(19) United States
(12) Patent Application Publication
(10) Pub. No.: US 2019/0042986 A1
(43) Pub. Date: Feb. 7, 2019

(54) Application Programming Interface for Vehicle Routing Applications

(71) Applicant: Google Inc., Mountain View, CA (US)

(72) Inventors: Vincent Furnon, Paris (FR); Kenneth Alton, Paris (FR); Fabien Viger, Paris (FR)

(21) Appl. No.: 15/668,292

(22) Filed: Aug. 3, 2017

(51) Int. Cl. G06Q 10/04; G06Q 10/08; G06Q 10/06; G01C 21/34

(52) U.S. Cl. CPC G06Q 10/047; G06Q 10/08; G01C 21/343; G06Q 10/08355; G06Q 10/0637

(57) ABSTRACT

Provided are systems and methods for a tour optimization application programming interface (API). The API can include a first set of instructions associated with a tour optimization data structure that can be associated with the API and specify a plurality of messages including one or more fields. The plurality of messages can be associated with a set of shipments and a set of vehicles. A second set of instructions can be associated with a modeling function that can implement one or more calls to generate model data based in part on the plurality of messages. A third set of instructions can be associated with implementation of a tour optimization service and can generate routing data for a user of the software application based on the model data. The routing data can include a set of routes based in part on the set of shipments and the set of vehicles.

### FIELD

The present disclosure relates generally to application programming interfaces for vehicle routing applications implemented on computing devices.

### BACKGROUND

Applications, including software applications, can be implemented on a variety of computing devices (e.g., laptop computers, smartphones, tablet computing devices, or wearable computing devices). These applications can perform a variety of functions associated with geographic information, including processing the geographic information for access and analysis by a user. The performance of these applications can be improved through the use of application programming interfaces (APIs) which can be designed to more efficiently create, modify, and access the services, frameworks, and structures of the applications. However, applications and the way applications are used can change over time, as can the underlying hardware that implements the applications. Accordingly, there exists a demand for more effective APIs that can be used to more efficiently leverage computing resources associated with geographic information.

### SUMMARY

Aspects and advantages of embodiments of the present disclosure will be set forth in part in the following description, or may be learned from the description, or may be learned through practice of the embodiments.

One example aspect of the present disclosure is directed to a non-transitory computer-readable medium storing computer-readable instructions that implement an application programming interface for generating model data for a software application executed on a computing device. The computing device can include one or more processors and a display device. The application programming interface can include a first set of instructions associated with a tour optimization data structure. The tour optimization data structure can be associated with the application programming interface and can specify a plurality of messages comprising one or more fields. The plurality of messages can be associated with a set of shipments and a set of vehicles. The application programming interface can include a second set of instructions associated with a modeling function. The modeling function can implement one or more calls to generate the model data based in part on the plurality of messages. The application programming interface can include a third set of instructions associated with implementation of a tour optimization service to generate routing data for a user of the software application based on the model data. The routing data can comprise a set of routes based in part on the set of shipments and the set of vehicles.

Another example aspect of the present disclosure is directed to a method for generating navigation data for a software application executed on a computing device having one or more processors. The method can include, receiving, by one or more computing devices, tour optimization data comprising a tour optimization data structure associated with an application programming interface and specifying a plurality of messages comprising one or more fields. The plurality of messages can be associated with a set of shipments and a set of vehicles. The method can include, generating, by the one or more computing devices, model data based in part on one or more calls to a modeling function associated with the plurality of messages. The plurality of messages can be associated with the modeling function and can include one or more shipment messages associated with the set of shipments or one or more vehicle messages associated with the set of vehicles. The method can include, generating, by the one or more computing devices, routing data for a user of the software application based on the model data. The routing data can include a set of routes based in part on the set of shipments and the set of vehicles.

Another example aspect of the present disclosure is directed to a computing device that includes a network interface, one or more processors, and one or more memory devices. The one or more memory devices can store computer-readable instructions that implement an application programming interface invoked by a software application to generate model data for a tour optimization service as part of the software application. A first set of instructions can be associated with a tour optimization data structure. The tour optimization data structure can be associated with the application programming interface and can specify a plurality of messages comprising one or more fields. The plurality of messages can be associated with a set of shipments and a set of vehicles. A second set of instructions can be associated with a modeling function. The modeling function can implement one or more calls to generate the model data based in part on the plurality of messages. A third set of instructions can be associated with implementation of the tour optimization service to generate routing data for a user of the software application based on the model data. The routing data can include a set of routes based in part on the set of shipments and the set of vehicles.

Other example aspects of the present disclosure are directed to other computer-implemented methods, systems, apparatus, tangible non-transitory computer-readable media, user interfaces, memory devices, and electronic devices for implementing an application programming interface for generating model data for a software application executed on a computing device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system for implementing a navigation service as part of a software application according to example embodiments of the present disclosure;

FIG. 2 depicts an example graphical user interface component implemented as part of a software application operating on a user device according to example embodiments of the present disclosure;

FIG. 3 depicts a block diagram of an example user device implementing a software application according to example embodiments of the present disclosure;

FIG. 4 depicts a block diagram of an example of instructions associated with an application programming interface according to example aspects of the present disclosure;

FIG. 5 depicts a block diagram of an overview of the relationship between messages in a tour optimization data structure according to example aspects of the present disclosure;

FIG. 6 depicts a block diagram of an example ShipmentModel message according to example aspects of the present disclosure;

FIG. 7 depicts a block diagram of an example vehicle message according to example aspects of the present disclosure;

FIG. 8 depicts a block diagram of an example shipment message according to example aspects of the present disclosure;

FIG. 9 depicts a block diagram of an example CapacityQuantity message according to example aspects of the present disclosure;

FIG. 10 depicts a block diagram of an example VisitRequestAlternates message according to example aspects of the present disclosure;

FIG. 11 depicts a block diagram of an example VisitRequest message according to example aspects of the present disclosure; and

FIG. 12 depicts a flow diagram of an example method according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the disclosed technology are directed to application programming interfaces (“APIs”) for generating model data in software applications that can be implemented on one or more computing devices to provide a set of routes for vehicles and shipments including an optimized set of routes for the vehicles and shipments. The disclosed technology can be implemented in one or more methods, systems, devices, or computer-readable media (e.g., non-transitory computer-readable media). In particular, the API can be used to generate models including transportation or routing models (e.g., vehicle routing models) that include a set of entities (e.g., vehicles, workers, units) that can perform (e.g., pickup, deliver, or transport) a set of tasks (e.g., shipments, workloads, or orders) from various locations (e.g., geographic locations). Further, the API can specify a set of classes, data structures, and/or protocols that includes one or more messages which can be used to specify aspects of a routing scenario including the set of vehicles and the set of shipments. The one or more messages can include one or more fields that can be used to specify properties and values for the one or more messages and can be used as constraints to define a set of routes for the set of vehicles and the set of shipments.

The disclosed technology can be implemented in a software application (e.g., a web application) that can be executed on one or more computing devices including local computing devices (e.g., on a mobile computing device or desktop computing device) or remote computing devices (e.g., on a remote server device). As such, the disclosed technology can include sets of computer-readable instructions that, when executed by one or more processors, implement an application programming interface that is used in the generation of model data including a set of vehicles and shipments. Accordingly, the disclosed technology can facilitate optimization of vehicle routes (e.g., optimal assignment of vehicles to shipments) based on one or more criteria (e.g., capacity or time constraints of the vehicles or shipments) which can be defined in the one or more messages and corresponding one or more fields.

In some embodiments, the API can include a first set of instructions associated with various types of data structures including a tour optimization data structure. The tour optimization data structure can be used to specify a plurality of messages, each of which can include one or more fields. The plurality of messages can be associated with a set of tasks, (e.g., shipments, workloads, consignments, or work orders) and a set of entities (e.g., vehicles, workers, employees, or work units) that can be used to create model data (for a model of the set of tasks and entities), that can in turn be used by a tour optimization service to generate a set of routes or paths for the set of tasks (e.g., shipments) and the set of entities (e.g., vehicles) that can perform the tasks.

For example, the plurality of messages can be used to specify information for vehicles and shipments in a shipment model including a ShipmentModel message, one or more vehicle messages, one or more shipment messages, one or more CapacityQuantity messages, one or more VisitRequestAlternates messages, or one or more VisitRequest messages. Further, each of the plurality of messages can be used to specify different aspects of the shipment model and can be interrelated with one another including interrelations in the form of dependency relationships (e.g., parent-child relationships between the different types of the plurality of messages).

Aspects of the present disclosure refer to a variety of terms including class, function, property, message, field, and protocol names (e.g., vehicles, shipments, and CapacityQuantity). These and other terms used in the present disclosure are provided for identification purposes only and are not intended to limit the scope of the present disclosure. For example, a ShipmentModel data structure or ShipmentModel message can include any data structure or message, regardless of name, that includes one or more aspects of the ShipmentModel data structure or ShipmentModel message described herein.

Additionally, the API can include a second set of instructions associated with a modeling function. The modeling function can be used to implement one or more calls to generate the model data based in part on the plurality of messages specified by the tour optimization data structure. The model data can describe a shipment model that includes the set of shipments, the set of vehicles, or the various events, objects, conditions, or states associated generating the shipment model. For example, the model data associated with the set of shipments can include locations of the shipments and shipment weights (e.g., the weight of cargo at a shipment location), and a set of vehicles including the locations of the vehicles and the carrying capacity of the vehicles. Accordingly, the model data can include or be associated with one or more fields that can be associated with messages including the ShipmentModel message, the one or more vehicle messages, the one or more shipment messages, the one or more CapacityQuantity messages, the one or more VisitRequestAlternates messages, or the one or more VisitRequest messages.

For example, the ShipmentModel message can include the one or more shipment messages, a shipments field, the one or more vehicle messages, a vehicles field, a travel duration seconds field, a global start time field, a global end time field, or a cost per hour of global duration field. The ShipmentModel message can represent a shipment model including the set of shipments to be performed by a set of vehicles. The shipment model associated with the ShipmentModel message can be used to minimize the overall cost of the vehicles performing the set of shipments based on cost criteria including the sum of the costs of routing the vehicles. For example, the costs can be based on the cost per total time, cost per travel time, or fixed cost for all vehicles; an unperformed shipment penalty (e.g., a penalty for shipments that are not performed within a specified time window); and the cost of the global duration of the shipments.

The shipment field of the ShipmentModel message can be associated with the set of shipments to be performed (e.g., picked up or delivered by a vehicle) and the vehicles field of the ShipmentModel message can be associated with the set of vehicles that is used to visit the locations to perform pickup or delivery of the shipments.

The travel duration seconds field of the ShipmentModel message can be based on a travel duration matrix which can include locations and the travel duration between any set of locations in the matrix. For example, the travel duration matrix can include a set of departure locations or arrival locations and a time (e.g., a time in seconds) that it takes for a vehicle to travel from a departure location to an arrival location. In the event that the travel duration seconds field is not provided or the travel duration seconds value is not specified, then the departure location field and the arrival location field associated with the vehicles messages and the VisitRequests messages can be specified instead. In this way, some information relating to the time or distance between shipments is available for use in the shipment model. However, if the travel duration seconds field is specified, then, to prevent conflicting information with respect to travel duration, the departure location field and the arrival location field of the vehicle message and VisitRequests messages will not be specified.

In some embodiments, the travel duration of a vehicle traveling from a departure location to an arrival location can be calculated by a service associated with the ShipmentModel message. Further, the number of elements in the travel duration matrix can be based on the product of the number of arrivals and the number of departures (i.e. the number of arrivals multiplied by the number of departures). The value of 1 can be added to the number of arrivals and the number of departures respectively, in order to properly format the travel duration matrix. The travel duration can be limited based on various criteria including a requirement that the duration of travel is not negative (i.e., a vehicle cannot take less than zero seconds to travel from a departure location to an arrival location). Additionally, travel duration can be specified as an infinite value to indicate that the corresponding path is not available (e.g., a path with a duration exceeding a predefined threshold time).

The global start time field and the global end time field of the ShipmentModel message can be associated with respective times (e.g., UNIX times). The difference between the values of the global start time field and the global end time field can represent the interval of valid times for the ShipmentModel message. The cost per hour of global duration of the ShipmentModel message can be associated with the cost of the overall duration of the shipment plan. The global duration can be the difference between the earliest start time and the latest end time of shipments by all of the vehicles. In some embodiments, the cost per hour of global duration can be based on the penalty cost associated with a shipment.

The one or more vehicle messages can include at least one of the one or more CapacityQuantity messages associated with a capacities field to specify the carrying capacity of each vehicle; a departure location field to specify a geographic location where a vehicle departs from before making a pick-up; an arrival location field to specify a geographic location that a vehicle is at after completing its last shipment; a departure index field to specify a travel time for the first leg of a route for the vehicle; an arrival index field to specify a travel time for the last leg of a route for the vehicle; an earliest start time field to specify the time at which the vehicle may depart for a shipment from a starting location; a latest end time field to specify the time at which the vehicle may arrive at its ending location; a cost per hour field to specify a cost to the total time taken by the vehicle to make a shipment including travel time, waiting time, and visiting time; a cost per hour traveled field to specify a cost to the time taken by the vehicle in transit from one location to another without waiting time or visit time; or a fixed cost field to specify a cost whenever a vehicle is used to make at least one shipment.

The one or more shipment messages can include at least one of the one or more CapacityQuantity messages and an associated demands field which can specify a type and quantity of a shipment; one or more VisitRequestAlternates messages associated with a pickup field or a delivery field; a pickup field to specify a pick-up location for a shipment; an optional delivery field to specify a drop-off location for a shipment; a penalty cost field to specify a penalty cost that is added to the overall route cost if a shipment is not completed (i.e., picked-up or delivered), in an implementation, omitting the penalty cost field can be an indication that performance of a shipment is mandatory; or an allowed vehicle indices field specifying the set of vehicles that can perform a shipment.

Each of the one or more shipment messages can represent the shipment of one or more items, from pickup to delivery. Performance of a shipment associated with the one or more shipment messages can be associated with a vehicle visiting any of a pickup location or a delivery location (e.g., visiting a pickup location, a delivery location, or a pickup location and a delivery location). In the event that a vehicle visits a pickup location, the vehicle can decrease the vehicle's available capacity by the amount of the shipment at the pickup location (e.g., a shipment of cargo is loaded onto a vehicle). In the event that the vehicle visits a delivery location, the vehicle can increase the vehicle's available capacity by the amount of the shipment at the delivery location (e.g., a shipment of cargo is offloaded from a vehicle).

In some embodiments the one or more VisitRequestAlternates messages can be associated with the pickup field alone or with the pickup and delivery field. In the case of the one or more VisitRequestAlternates messages being associated with the pickup field alone, the vehicle is only requested to visit a pickup location. In the case of the one or more VisitRequestAlternates messages being associated with the pickup field and the delivery field, the vehicle can visit one pickup request alternate and one delivery request alternate. The demands field of a shipment message can be associated with the CapacityQuantity message and can be used to indicate the type and amount of a shipment that is to be picked up or delivered by a vehicle.

The VisitRequestAlternates message can include one or more VisitRequest messages, associated with a visit to a shipment location by a vehicle. As such, each of the one or more of the VisitRequestAlternates messages can include one or more VisitRequest messages or a visit requests field. Performance by the vehicle of only one of the set of visit requests can be sufficient to fulfill the request. The one or more VisitRequest messages can include an arrival location field, a departure location field, an arrival index field, a departure index field, a time windows field, a duration field, or a TimeWindow message.

The arrival location field can specify a geographic location (e.g., a geographic location expressed in terms of latitude and longitude) at which a vehicle arrives to make a pick-up or drop-off. The departure location can specify a geographic location from which a vehicle departs after making a pick-up or drop-off. The arrival index field can specify a time used by the vehicle to arrive at a location from a previous departure location. The departure index field can specify a time used by the vehicle to depart from a location to the next arrival location. The duration field can specify the duration of a visit by a vehicle to a shipment location (e.g., the time between a vehicle arriving at a location and the vehicle departing from that location).

The TimeWindow message can be used to constrain an arrival time of a vehicle for a shipment. The TimeWindow message can be associated with a start time field to indicate an earliest arrival time for a vehicle; an end time field to indicate a latest arrival time for a vehicle; a soft end time field to indicate an end time after which a waiting penalty is incurred; or a cost per hour after soft end time field to indicate the magnitude of the penalty after the soft end time is exceeded.

The one or more shipment messages or the one or more vehicle messages can be associated with one or more CapacityQuantity messages including a type field or a value field. The type field for the CapacityQuantity messages can include an identifier (e.g., a unique identifier) of a type of quantity that can be associated with the capacity of a vehicle or consumption of that capacity by a shipment. The type field of the CapacityQuantity messages can include an identifier of a type of quantity or units associated with the quantity (e.g., weight measured in units of ounces, volume measured in units of liters, mass measured in units of grams). The value field can include a value of the amount of the quantity that can be associated with the capacity of a vehicle or consumption of that capacity by a shipment. For example, the value field can include a numerical value (e.g., 10,000). In some embodiments, the value field can be limited to non-negative values (e.g., the capacity of a vehicle is limited to positive amounts).

In some embodiments, the one or more vehicle messages and the one or more shipment messages (corresponding to the set of vehicles and the set of shipments respectively) can be constrained by the type of the quantity associated with the type field or the amount of the quantity associated with the value field. For example, the one or more CapacityQuantity messages in the one or more shipment messages can include a type specifying a weight in tons and a value of two, which would constrain the model so that only vehicles with a carrying capacity of two tons or greater would be included, i.e., the model would not include vehicles with a carrying capacity of less than two tons.

The API can also be associated with a third set of instructions that can implement a tour optimization service to generate routing data for a user of a software application based on the model data. For example, the tour optimization service can process the model data and generate routing data that includes routes based on the plurality of messages associated with the set of shipments and the set of vehicles. Further, the routing data can include a set of the shipments and the set of vehicles that is constrained according to the one or more fields of the one or more shipment messages and the one or more vehicle messages. For example, the routing data can be output to a display device that shows a user a set of routes based on criteria of the vehicle optimization service (e.g., a target cost or travel duration for the set of shipments and vehicles).

In some implementations, the disclosed technology can include a fourth set of instructions that can be used to generate a graphical user interface component associated with the tour optimization service. The graphical user interface component can display graphical representations (e.g., including text and images) based on various data including the model data and the routing data. Further, the graphical user interface component can include interactive elements that allow a user to view or modify portions of the data that is displayed. For example, the graphical user interface component can allow the user to adjust the value of fields so that different constraints can be applied to location visits by the set of vehicles (e.g., changing the capacities of the vehicles). As such, the graphical user interface component can facilitate more effective generation and optimization of routing scenarios for a given set of vehicles and shipments.

Aspects of the present disclosure can provide a variety of technical effects and benefits through the particular configuration of the API, specifically the manner in which functions of the API are separated.

There is an improvement in the effectiveness of model generation, which can increase the efficiency of computing resource usage (e.g., reducing the time and computational resources used to generate a model). Since model generation is performed based on messages specified in a tour optimization data structure, it is possible to dynamically change the model by changing the messages in the data structure in accordance with a particular environment and specifications of shipments and vehicles. It is not necessary to change the modeling function itself, because the modeling function can be configured based on the format of the tour optimization data structure, such that it is capable of operating on any particular message within that format. The format can be selected in order to optimize the nature of the input to the API, such that a user can readily specify a particular environment via convenient and minimal interaction with the API, optimizing use of resources.

Further, the disclosed technology allows for specific improvements in the efficiency of generating routes and determining optimal ways of traversing the routes. Having optimized the model generation as described above, it follows that routing data can be analogously generated in an optimized manner because the routing data can be generated for any particular input to the tour optimization data structure. In some implementations, the process by which the routing data is generated can remain unchanged or minimally changed, because of the separation that can occur between the processes of generating routing data and the operation of the modeling function.

In other words, when the input to the tour optimization data structure is changed, the change can be processed by the modeling function, such that the new routing data is generated because of updated modeling function, rather than a change to the manner in which the routing data generation process interacts with the modeling function. The efficiency of generating routes can also improve the performance of individual vehicles and shipments in the model as well as resulting in more efficient apportionment of resources within the model. Accordingly, aspects of the present disclosure can allow for improved allocation of vehicles to shipments through use of an application programming interface.

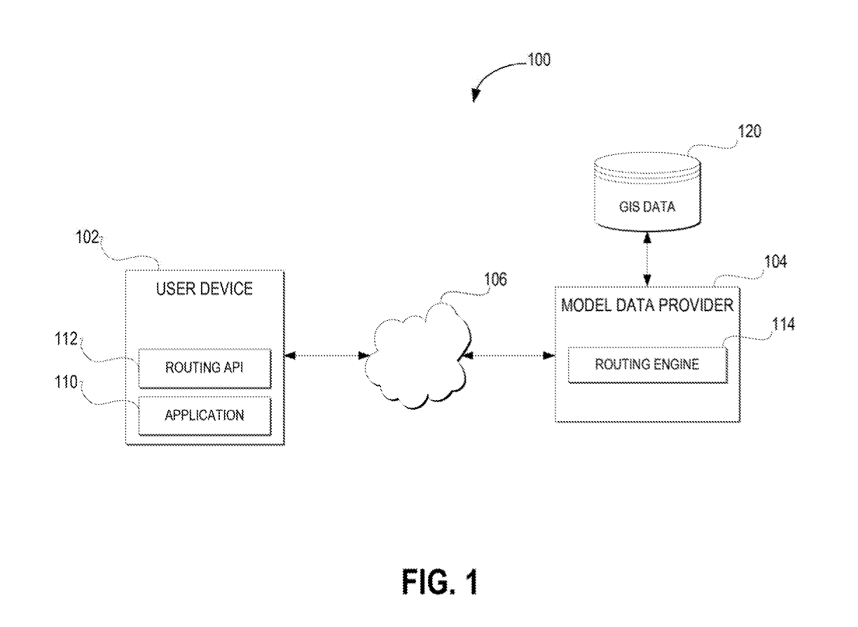

With reference now to the FIGS. 1-12, example aspects of the present disclosure will be disclosed in greater detail. FIG. 1 depicts an overview of an example system 100 for generating tour optimization data for an application (e.g., software application) according to example embodiments of the present disclosure. The system 100 can include a user device 102; model data provider 104; a communication network 106; an application 110 (e.g., a software application); a routing application programming interface 112 (“API 112”); a routing engine 114; and a geographic information system 120.

The user device 102 can receive navigation data from the model data provider 104 via a communication network 106. The application 110, which can operate or be executed on the user device 102, can interact with the navigation data provider 114 via the network 106. The network 106 can include any type of communications network, such as a local area network (e.g. intranet), wide area network (e.g. Internet), cellular network, or some combination thereof. The network 106 can also include a direct connection. In general, communication can be carried via network 106 using any type of wired and/or wireless connection, using a variety of communication protocols (e.g. TCP/IP, HTTP, SMTP, FTP), encodings or formats (e.g. HTML or XML), and/or protection schemes (e.g. VPN, secure HTTP, or SSL).

The user device 102 can include one or more computing devices including a smartphone, a tablet, a wearable device, a laptop computing device, a desktop computing device, a mobile computing device, a wearable computing device, a display device with one or more processors, or a vehicle computing system (e.g., a navigation system in an automobile).

The application 110 can be implemented on the user device 102. The application 110 can implement a routing service for model data and/or routing data to a user. The model data and/or the routing data can be based on the state of a plurality of vehicles and a plurality of shipments including various navigational data (e.g., geographic locations of the plurality of shipments and the plurality of vehicles, capacities of the plurality of vehicles, and routes for the plurality of vehicles). The application 110 can be operated or executed locally on the user device 102, through a web application accessed via a web browser implemented on the user device 102, or through a combination of local execution or operation on user device 102 and remote execution or operation on a remote computing device which can include the model data provider 104 or the geographic information system 120.

The application 110 can call the routing API 112 to control the routing engine 114 associated with a computing device (e.g., a remote computing device) including the model data provider 104. In this way, the routing API 112 can be used by the application 110 to access and provide model data, navigation data, and/or route data associated with the navigation data provider 1104 via a communication network including the communication network 106.

The application 110 can be configured to generate or determine model data including routing data or navigational data (e.g., the location and routes for vehicles and shipments in a shipment model) that can be used by a user. In some implementations, the application 110 can include a graphical user interface component for presenting the navigation information to the user on one or more display devices.

The API 112 can provide an interface for the routing engine 114 and the application 110. In this way, the model and/or routing parameters passed to the application 110 as part of the API 112 call can be used to automatically determine the model data or routing data by exchanging (sending or receiving) data with the routing engine 114. The routing engine 114 can be configured to, for instance, compute shipment routes to one or more vehicles, access mapping data including geographic locations of shipment locations, update routing data based on various vehicle or shipment events, and respond to requests for model data or routing data from the application 110.

The routing API 112 can be implemented in various ways including as one or several functions and/or as a data structure. Further, the API 112 may include compiled code that executes directly on a computing device including the user device 102 or the model data provider 104. Alternatively, instructions in any other form such as a scripting language can be interpreted at runtime by the application 110. The API 112 in one example implementation includes well-documented prototypes of several functions which a developer can include in the code of the application 110, as well as instructions that implement these functions. In some embodiments, the API 112 can be provided to the developer as a static library.

In some embodiments, the model data provider 104 can include one or more computing devices including servers (e.g., web servers). The one or more computing devices can include one or more processors and one or more memory devices. The one or more memory devices can store computer-readable instruction to implement, for example, the routing engine 114. In some embodiments, the routing engine 114 can access data associated, for instance, with a geographic information system 118.

The geographic information system 118 can be associated with or include data that is indexed according to geographic coordinates (e.g., latitude and longitude) of its constituent elements (e.g., locations). The data associated with the geographic information system 118 can include map data, route data, geographic imagery, and/or data associated with various waypoints (e.g., addresses or geographic coordinates). The model data or routing data as determined or generated by the model data provider 104 can be provided to the application 110 via the API 112. In some implementations, the application 110 can present the routing data within the user interface of the application 110.

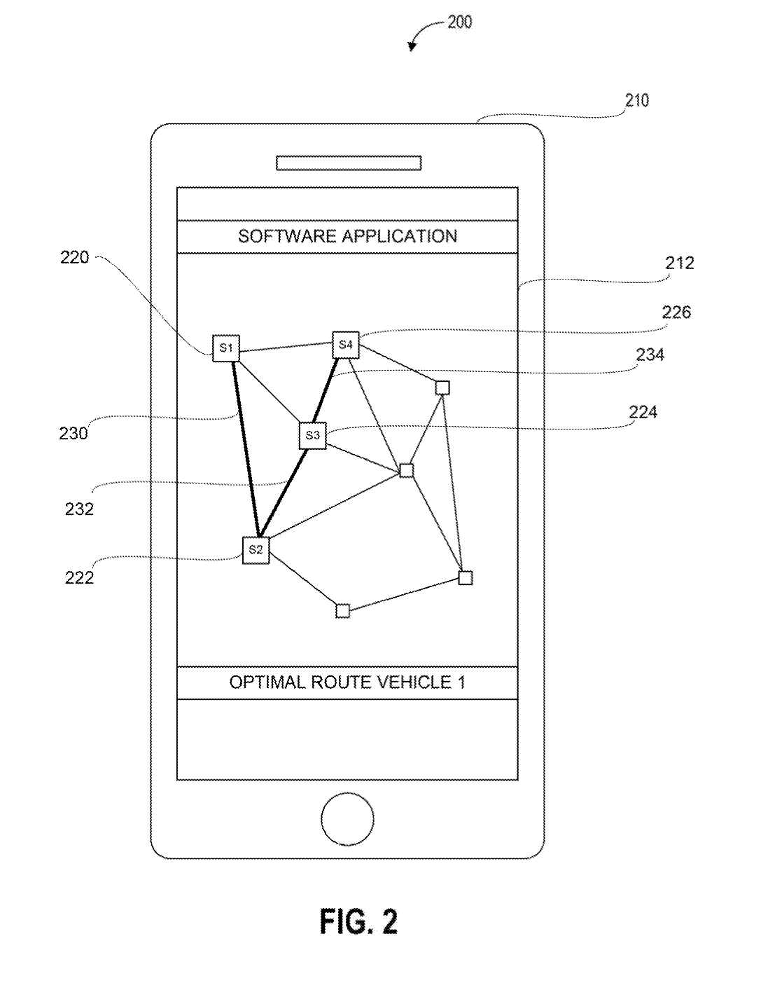

FIG. 2 depicts an example of a computing system 200 that includes a computing device 210 and a graphical user interface component 212 associated with a software application (e.g., the application 110) according to example embodiments of the present disclosure. The graphical user interface component 212 can be displayed on a display device of the computing device 210 (e.g., a display device of the user device 102). The graphical user interface component 212 can include various interface elements that can be used to access, generate, process, or present (e.g., display) data, including model data or routing data, to a user as part of a service including a tour optimization service. As shown in FIG. 2, the graphical user interface component 212 can include a display of a shipment location 220/222/224/226 (e.g., a symbolic representation of a geographic location) and a route segment 230/232/234 (e.g., a symbolic representation of a path or road between shipment locations).

The graphical user interface component 212 can include representations of data including the routing data or model data. The graphical user interface component 212 can display the routing data or model data using various combinations of text, pictures, and other types of symbols. The shipment location 220 can represent a first shipment location (e.g., a geographic location) for a vehicle to visit according to set of locations based on a shipment model for a vehicle according to a set of optimization criteria of the tour optimization service (e.g., the optimization criteria can include maximizing vehicle capacity or minimizing shipment times). The subsequent shipment locations including shipment location 222/224/226 can be represented on the graphical user interface component 212 as being connected or linked by the route segment 230/232/234.

According to example implementations of the present disclosure, an API (e.g., the routing API 112 in FIG. 1) can facilitate an invocation of an application (e.g., the application 110 in FIG. 1). The invocation of the application can cause the application to launch and/or execute on a computing device (e.g., the computing device 210 or the user device 102 shown in FIG. 1). The invocation of the application can further cause the application to be brought to the foreground of a user interface of the computing device 210, such that the user can view and/or interact with the application. For example, when the application 110 is not operating or being executed on the computing device 210, the application can be launched and brought to the foreground of the user interface responsive to the invocation.

The invocation of the application can occur responsive to a user interaction (e.g., touching a portion of the computing device 210) with an element (e.g., a graphical user interface element including a user input control element) displayed within a user interface of the software application operating or being executed on the computing device 210.

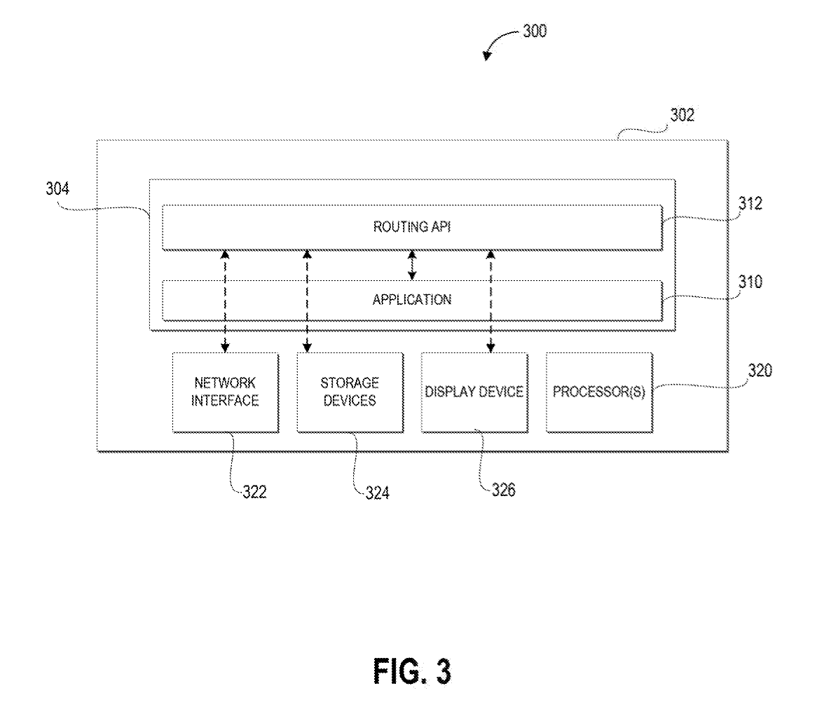

FIG. 3 depicts an example user device 302 configured to implement a routing API 312 according to example embodiments of the present disclosure. As shown, the user device 302 can include a memory 304; an application 310 that can include one or more instructions and that can be stored on the memory 304 (e.g., RAM); a routing API 312 that can include one or more instructions that can be stored on the memory 304; one or more processors 320 configured to execute the one or more instructions stored in the memory 304; a network interface 322 that can support network communications; a storage device 324 (e.g., a hard disk drive or a solid state drive); and/or a display device 326. The one or more processors 320 can include any processing device that can, for example, process and/or exchange (send or receive) one or more signals or data associated with a computing device.

For example, the one or more processors 320 can include single or multiple core devices including a microprocessor, microcontroller, integrated circuit, and/or logic device. The memory 304 and the storage device 324 are illustrated separately, however, the memory 304 and the storage device 324 can be regions within the same memory module. The user device 302 can include one or more additional processors, memory devices, network interfaces, which may be provided separately or on a same chip or board. The memory 304 and the storage device 324 can include one or more computer-readable media, including, but not limited to, non-transitory computer-readable media, RAM, ROM, hard drives, flash drives, and/or other memory devices.

The memory 304 can store sets of instructions for applications including an operating system that can be associated with various software applications or data. The memory 304 can be used to operate various applications including a mobile operating system developed specifically for mobile devices. As such, the memory 304 can perform functions that allow the software applications to access data including wireless network parameters (e.g., identity of the wireless network, quality of service), and invoke various services including telephony, location determination (e.g., via global positioning service (GPS) or WLAN), and/or wireless network data call origination services. In other implementations, the memory 304 can be used to operate or execute a general-purpose operating system that operates on both mobile and stationary devices, such as smartphones and desktop computers, for example. In some example implementations, the operating system includes or based upon an Android® mobile operating system developed by Google Inc. or other operating system to implement an Android operating platform.

The software applications that can be operated or executed by the user device 302 can include the application 110 shown in FIG. 1. Further, the software applications that can be operated or executed by the user device 302 can include native applications or web-based applications.

In some implementations, the user device can be associated with or include a positioning system (not shown). The positioning system can include one or more devices or circuitry for determining the position of a device. For example, the positioning device can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position. The positioning system can determine a user location of the user device. The user location can be provided to the model data provider 104 for use by the navigation data provider in determining travel data associated with the user device 102.

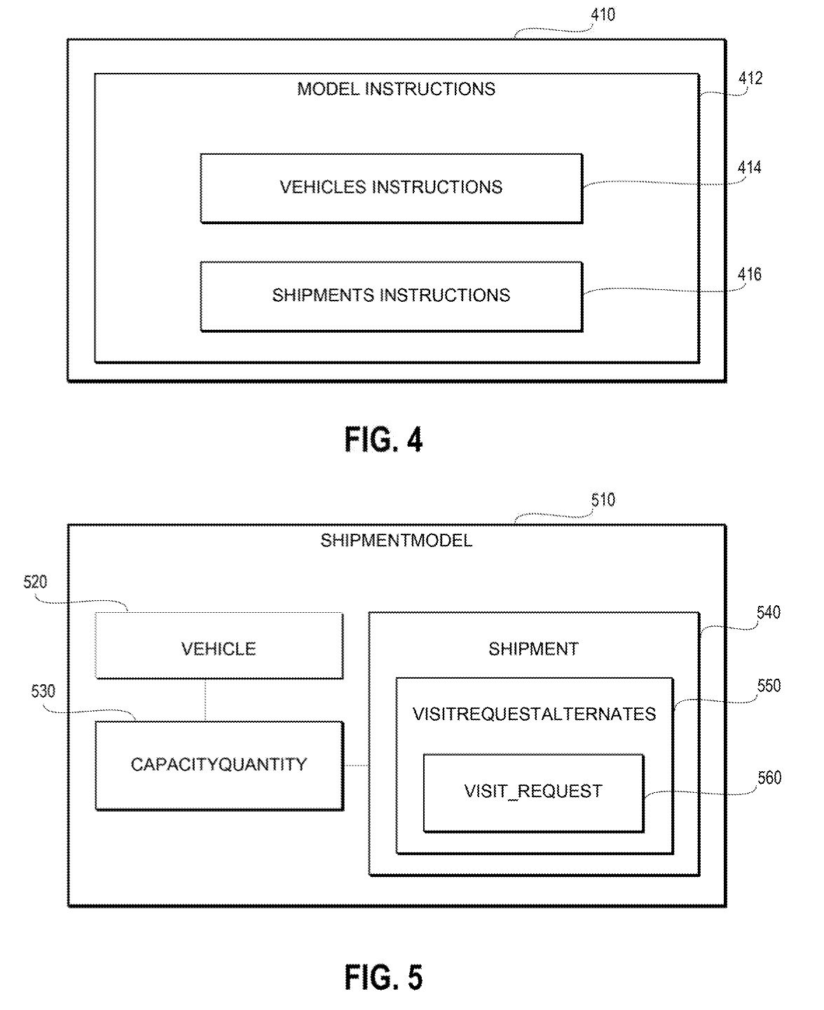

FIG. 4 depicts a block diagram of an example device 410 (e.g., a computing device with one or more processors and a memory) that can store, process, generate, and/or exchange (send or receive) sets of instructions associated with an API (e.g., the routing API 112) according to example embodiments of the present disclosure. One or more of the instructions stored on the device 410 can be executed or implemented on one or more computing devices or computing systems including, for example, the user device 102, the model data provider 104, and/or the computing device 302. Further, one or more of the instructions stored on the device 410 can be executed or implemented as an algorithm on the hardware components of the devices disclosed herein. As shown, the one or more instructions can include model instructions 412, vehicles instructions 414, and/or shipments instructions 416.

The model instructions 412 can be implemented by associating the model instructions 412 with an application so that the application can generate models associated with a service (e.g., a tour optimization service) that can, for example, be used to optimize the pick-up and delivery of a set of shipments by a set of vehicles. Further, the model instructions 412 can be associated with or include the vehicles instructions 414 and/or the shipments instructions 416.

The vehicles instructions 414 can be used to describe various aspects of one or more vehicles that can be specified by an API. The vehicles instructions 414 can be associated with or include one or more data structures including one or more classes, one or more objects, or one or more messages, any of which can be associated with a protocol buffer. The one or more data structures associated with the vehicles instructions 414 can include a departure location data structure including a latitude field and a longitude field associated with the respective latitude and longitude from which the vehicle departs; an earliest start time data structure associated with a pick-up time or delivery time of the vehicle; a latest end time data structure associated with a pick-up time or delivery time of the vehicle; a capacities data structure which can include a type field associated with the type of cargo carried by the vehicle and a value field associated with the amount of cargo carried by the vehicle; and/or a cost per traveled hour data structure that can indicate a rate at which the vehicle expends resources (e.g., dollars per hour, gallons of fuel per hour, or watts per hour).

The shipments instructions 416 can be used to describe various aspects of one or more shipments which can be specified by an API. The shipments instructions 416 can be associated with or include one or more data structures including a class, various objects, or a message that can be associated with a protocol buffer. The one or more data structures associated with the shipments instructions 416 can include a pickup data structure associated with a shipment to be picked up by a vehicle. The pickup data structure can be associated with or include an arrival location data structure including a latitude field and a longitude field associated with the respective latitude and longitude from which the vehicle departs; and a time window data structure associated with a time range for the pickup or delivery by a vehicle to occur.

The time window data structure can include a start time data structure associated with a start of a pick-up or delivery time and an end time data structure associated with an end of the pick-up or delivery time; a duration data structure which can be associated with the duration of a pickup or delivery; and a demands data structure associated with the quantity of cargo to be picked up or delivered to a location. In some implementations, the demands data structure can include a type field for the type of cargo and a value field for the quantity of the cargo.

An example implementation of instructions including the model instructions 412, the vehicles instructions 414, and the shipments instructions 416 is provided as follows:

model {

shipments {

pickup {

visit_requests {

arrival_location {

latitude: 48.843561
longitude: 2.297602

}
time_windows {

start_time {

seconds: 912000

}
end_time {

seconds: 967000

}

}
duration {

seconds: 90000

}

}

}
demands {

type: “Load”
value: 10

}

}
shipments {

pickup {

visit_requests {

arrival_location {

latitude: 48.834862
longitude: 2.309275

}
time_windows {

start_time {

seconds: 825000

}
end_time {

seconds: 870000

}

}
duration {

seconds: 90000

}

}

}
demands {

type: “Load”
value: 30

}

}
shipments {

pickup {

visit_requests {

arrival_location {

latitude: 48.830455
longitude: 2.318888
}
time_windows {
start_time {

seconds: 65000

}
end_time {

seconds: 146000

}

}

duration {

seconds: 90000

}

}

}
demands {

type: “Load”
value: 10

}
}

shipments {

pickup {

visit_requests {

arrival_location {

latitude: 48.826387
longitude: 2.363691
}

time_windows {

start_time {
seconds: 727000

}
end_time {

seconds: 782000

}

}
duration {

seconds: 90000
}

}

}
demands {

type: “Load”
value: 10

}

}
shipments {

pickup {

visit_requests {

arrival_location {

latitude: 48.84503
longitude: 2.391672

}
time_windows {

start_time {

seconds: 15000

}
end_time {

seconds: 67000

}

}
duration {

seconds: 90000

}

}

}
demands {

type: “Load”
value: 10

}

}
shipments {

pickup {

visit_requests {

arrival_location {

latitude: 48.858246
longitude: 2.375536

}
time_windows {

start_time {
seconds: 621000
}
end_time {

seconds: 702000

}

}
duration {

seconds: 90000

}

}

}
demands {

type: “Load”
value: 20

}

}
shipments {

pickup {

visit_requests {

arrival_location {

latitude: 48.875071
longitude: 2.392874

}
time_windows {

start_time {
seconds: 170000
}
end_time {

seconds: 225000

}

}
duration {

seconds: 90000

}

}

}
demands {

type: “Load”
value: 20

}

}
shipments {

pickup {

visit_requests {

arrival_location {

latitude: 48.880942
longitude: 2.323866

}
time_windows {

start_time {

seconds: 255000

}
end_time {

seconds: 324000

}

}
duration {

seconds: 90000

}

}

}

demands {

type: “Load”
value: 20

}

}
shipments {

pickup {

visit_requests {

arrival_location {

latitude: 48.874507
longitude: 2.30361

}
time_windows {

start_time {

seconds: 534000

}
end_time {

seconds: 605000

}

}
duration {

seconds: 90000

}

}

}
demands {

type: “Load”
value: 10

}

}
vehicles {

departure_location {

latitude: 48.863102
longitude: 2.341204

}
earliest_start_time {
}
latest_end_time {

seconds: 1236000

}
capacities {

type: “Load”
value: 200

}
cost_per_traveled_hour: 3600

}
vehicles {

departure_location {

latitude: 48.863102
longitude: 2.341204

}earliest_start_time {
}
latest_end_time {

seconds: 1236000

}
capacities {

type: “Load”
value: 200

}
cost_per_traveled_hour: 3600

}
vehicles {

departure_location {

latitude: 48.863102
longitude: 2.341204

}earliest_start_time {
}
latest_end_time {

seconds: 1236000

}
capacities {

type: “Load”
value: 200

}
cost_per_traveled_hour: 3600
}

}

FIG. 5 depicts a block diagram of an example ShipmentModel data structure 510 that can be associated with an API (e.g., the routing API 112) according to example embodiments of the present disclosure. One or more of the ShipmentModel data structure 510 can be executed or implemented on one or more computing devices or computing systems including, for example, the user device 102, the model data provider 104, and/or the computing device 302. Further, one or more of the ShipmentModel data structure 510 can be executed or implemented as an algorithm on the hardware components of the devices disclosed herein.

The ShipmentModel data structure 510 (e.g., a ShipmentModel message) can be associated with or include one or more data structures including a class, various objects, or a message that can be associated with a protocol buffer. The one or more data structures associated with, or included in, the ShipmentModel data structure 510 can be associated with a shipping model including one or more vehicles, one or more shipments, and one or more associated properties (e.g., locations of vehicles and shipments). The shipment_model 510 can include one or more of: a vehicle message 520; a CapacityQuantity message 530; a shipment message 540; a VisitRequestAlternates message 550; and/or a VisitRequest message 560.

In some implementations, the ShipmentModel data structure 510 can be associated with or include a vehicle message that can include a vehicles field; a shipment message that can include a shipments field; a travel_duration_seconds field; a global_start_time field; a global_end_time field; and/or a cost_per_hour_of_global_duration field.

The vehicle message 520 can be associated with or include one or more data structures including a class, various objects, or a message that can be associated with a protocol buffer. The one or more data structures associated with the vehicle message 520 can be associated with one or more vehicles including properties of the vehicles (e.g., vehicle capacity). The one or more data structures associated with the vehicle message 520 can include a CapacityQuantity message 530, which can include a capacities field; a departure_location field; an arrival_location field; a departure_index field; an arrival_index field; an earliest_start_time field; a latest_end_time field; a cost_per_hour field; a cost_per_traveled_hour field; and/or a fixed_cost field.

The CapacityQuantity message 530 can be associated with or include one or more data structures including a class, various objects, or a message that can be associated with a protocol buffer. The one or more data structures associated with the CapacityQuantity message 530 can be associated with one or more capacities of vehicles or shipments. The one or more data structures associated with the CapacityQuantity message 530 can include one or more of a type field and/or a value field.

The shipment message 540 can be associated with or include one or more data structures including a class, various objects, or a message that can be associated with a protocol buffer. The one or more data structures associated with the shipment message 540 can be associated with one or more shipments that can be picked up or delivered. The shipment message 540 can be associated with or include the VisitRequestAlternates message 550 and/or the VisitRequest message 560. Further, the shipment message 540 can be associated with or include a CapacityQuantity message that can include a demands field; a VisitRequestAlternates message that can include a pickup field and/or a delivery field; a penalty_cost field; and/or an allowed_vehicle_indices field.

The VisitRequestAlternates message 550 can be associated with or include one or more data structures including a class, various objects, or a message that can be associated with a protocol buffer. The one or more data structures associated with the VisitRequestAlternates message 550 can be associated with visits to one or more locations for a pickup or delivery of a shipment. The VisitRequestAlternates message 550 can be associated with or include the VisitRequest message 560 which can include a visit_requests field.

The VisitRequest message 560 can be associated with or include one or more data structures including a class, various objects, or a message that can be associated with a protocol buffer. The one or more data structures associated with the VisitRequest message 560 can be associated with visits to one or more locations for a pickup or delivery. The VisitRequest message 560 can be associated with or include a time window message that can include one or more time_windows fields; a duration field; an arrival_location field; a departure_location field; an arrival_index field; a departure_index field; a start_time field; an end_time field; a soft_end_time field; and/or a cost_per_hour_after_soft_end_time field.

The shipment model message 510; the vehicle message 520; the CapacityQuantity message 530; the shipment message 540; the VisitRequestAlternates message 550; and/or a VisitRequest message 560 can be used to specify different aspects of the shipment model message 510. Further, the vehicle message 520; the CapacityQuantity message 530; the shipment message 540; the VisitRequestAlternates message 550; and/or a VisitRequest message 560 can be associated or interrelated with one another including associations or interrelations in the form of dependency relationships (e.g., parent-child relationships between the different types of messages).

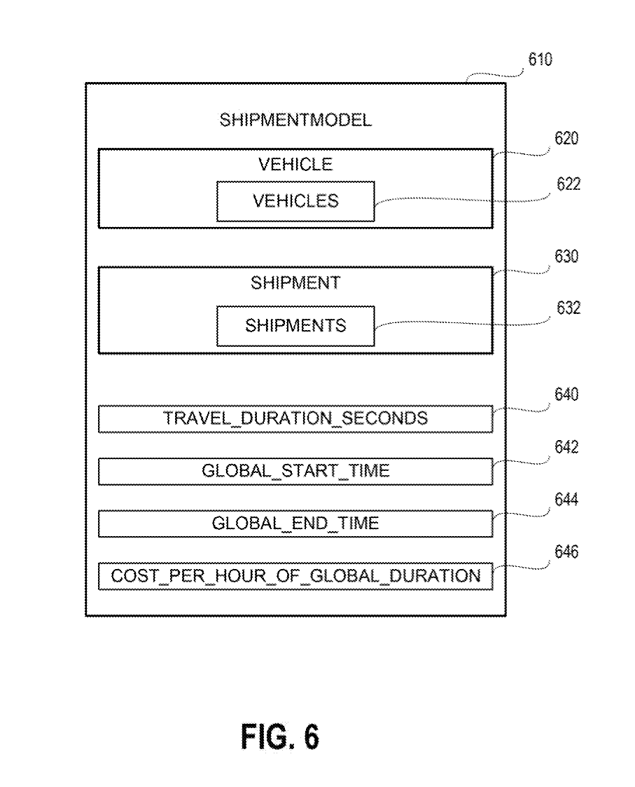

FIG. 6 depicts a block diagram of a ShipmentModel data structure 610 that can be associated with an API (e.g., the routing API 112) according to example embodiments of the present disclosure. One or more ShipmentModel messages, including the ShipmentModel data structure 610, can be executed or implemented on one or more computing devices or computing systems including, for example, the user device 102, the model data provider 104, and/or the computing device 302. Further, one or more of the ShipmentModel data structure 610 can be executed or implemented as an algorithm on the hardware components of the devices disclosed herein.

As shown, the ShipmentModel data structure 610 (e.g., a ShipmentModel message) can be associated with or include one or more of: a vehicle data structure 620 (e.g., a vehicle message) which can include a vehicles field 622; a shipment data structure 630 (e.g., a shipment message) that can include a shipments field 632; a travel_duration_seconds field 640; a global_start_time field 642; a global_end_time field 644; and/or a cost_per_hour_of_global_duration field 646.

The ShipmentModel data structure 610 can be associated with or include one or more other data structures including a class, various objects, or a message that can be associated with a protocol buffer. The one or more data structures associated with the ShipmentModel data structure 610 can be associated with a shipment model that includes a set of shipments to be performed by a set of vehicles. An application (e.g., the application 110) can generate a shipment model associated with the ShipmentModel data structure 610. The shipment model associated with the ShipmentModel data structure 610 can be used in a variety of models including the set of vehicles which can be associated with the vehicle data structure 620 and the set of shipments which can be associated with the shipment data structure 630.

The vehicle data structure 620 can be used to instantiate one or more vehicle objects including the vehicles field 622. The vehicles field 622 can be associated with the set of vehicles that is used to visit the locations to perform pickup or delivery of the shipments. By way of example, the vehicles field can be associated with the number of the vehicles in the set of vehicles (e.g., “Vehicle vehicles=4” can indicate the instantiation of 4 vehicles objects in a shipment model).

The shipment data structure 630 can be used to instantiate a set of shipments objects including the shipments field 632. The shipments field 632 can be associated with the set of shipments to be performed (e.g., picked up or delivered by a vehicle). For example, the shipments field 632 can be associated with the number of shipments to be performed by the set of vehicles (e.g., “Shipment shipments=2” can indicate the instantiation of 2 shipments objects in a shipment model).

The travel_duration_seconds field 640 can be based on a set of travel durations (e.g., a travel time used by a vehicle to transport a shipment from a pickup location to a delivery location). The set of travel durations can be stored in a dataset that can include a travel duration matrix. The travel duration matrix can include a set of locations (e.g., locations identified by a location identifier or a latitude/longitude) and the travel duration (e.g., a duration in seconds) between any of the set of locations in the travel duration matrix.

For example, the travel duration matrix can include a set of locations that is on the axes of the travel duration matrix, with a set of travel durations at the intersection of the set of locations. The set of travel durations (e.g., a travel time in seconds) can indicate the tie that a vehicle takes to travel from one of the locations to another one of the locations. In one implementation, the travel duration from a location to the same location can be indicated in the travel duration matrix as having a travel duration of zero (e.g., zero seconds).

In some implementations, when the travel_duration_seconds field 640 is not provided or not associated with a travel duration value (e.g. a time in seconds), then a departure_location field or an arrival_location field associated with the vehicles message 620 or a VisitRequest message can be specified. In this way, data or information associated with either the travel duration or the travel distance that is used by a vehicle as it performs a shipment is provided to the shipment model. In another implementation, when the travel_duration_seconds field 640 is provided or associated with a travel duration value (e.g., a time in seconds), the departure_location field or the arrival_location field associated with the vehicle data structure 620 or a VisitRequest message will not be specified.

In some implementations, the travel duration of a vehicle traveling from one location (e.g., a departure location) to another location (e.g., an arrival location) can be determined by a service including an application or set of applications associated with the ShipmentModel data structure 610. Further, the number of rows and columns in the travel duration matrix can be based on the number of arrivals and the number of departures. For example, a travel duration matrix with ten departures and five arrivals would have fifty elements. The travel duration can be limited based on various criteria including a requirement that the duration of travel is not negative (i.e., a vehicle cannot take less than zero seconds to travel from a departure location to an arrival location). Additionally, travel duration can be specified as a predetermined value (e.g., ten years) to indicate that the corresponding path is not available (e.g., a travel route with a duration exceeding a predefined threshold time).

Each of the global_start_time field 642 and/or the global_end_time field 644 can be associated with a time including a time of day (e.g., an epoch time, posix time, or UNIX time). The global_start_time field 642 and/or the global_end_time field 644 can include a value (e.g., a numerical value) for a time from a predetermined starting time (e.g., the number of seconds since Jan. 1, 1970). The difference between the values of the global_start_time field 642 and the global_end_time field 644 can represent the intervals of valid times that can be used by the ShipmentModel data structure 610.

The cost_per_hour_of_global_duration 646 can be associated with the cost of the overall duration of the shipment plan. The global duration can be the difference between the earliest start time and the latest end time of shipments by all of the vehicles. In some embodiments, the cost per hour of global duration can be based on the penalty cost of associated with a shipment.

An example implementation of a ShipmentModel data structure 610 is provided as follows:

message ShipmentModel {

repeated Shipment shipments = 1;
repeated Vehicle vehicles = 2;
repeated int64 travel_durations_seconds = 3;
google.protobuf.Timestamp global_start_time = 5;
google.protobuf.Timestamp global_end_time = 6;
double cost_per_hour_of_global_duration = 7;

}

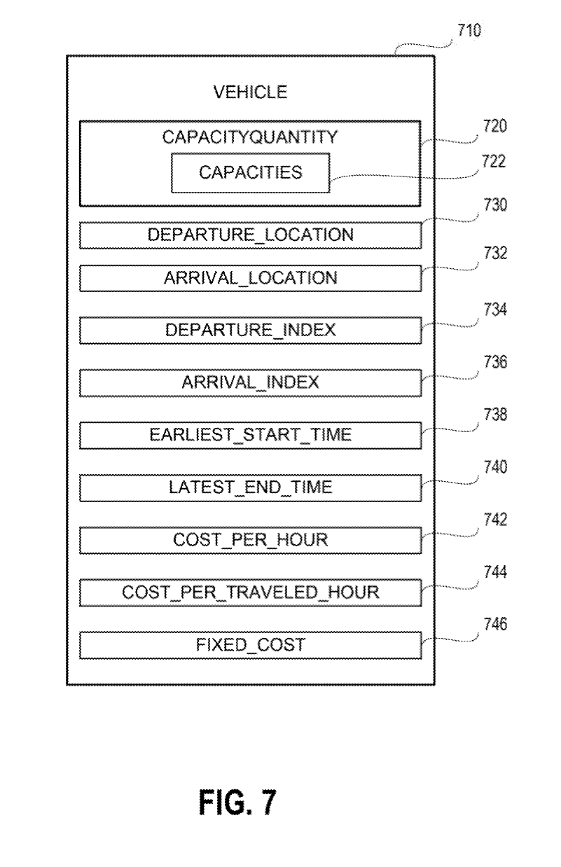

FIG. 7 depicts a block diagram of example sets of a vehicle data structure 710 which can be associated with an API (e.g., the routing API 112) according to example embodiments of the present disclosure. One or more vehicle messages including the vehicle data structure 710 can be executed or implemented on one or more computing devices or computing systems including, for example, the user device 102, the model data provider 104, and/or the computing device 302. Further, the vehicle data structure 710 can be executed or implemented as an algorithm on the hardware components of the devices disclosed herein. As shown, the vehicle data structure 710 can include or be associated with one or more of a CapacityQuantity data structure 720 (e.g., a CapacityQuantity message) that can include a capacities field 722; a departure_location field 730; an arrival_location field 732; a departure_index field 734; an arrival_index field 736; an earliest_start_time field 738; a latest_end_time field 740; a cost_per_hour field 742; a cost_per_traveled_hour field 744; and/or a fixed_cost field 746.

The vehicle data structure 710 (e.g., a vehicle message) can be associated with or include one or more data structures including a class, various objects, or a message that can be associated with a protocol buffer. The vehicle data structure 710 can be associated with a vehicle that travels a route (e.g., a shipment route) that can include one or more locations at which shipments can be dropped off or picked up. The route can start at a location associated with the departure_location field 730 or the departure_index field 734 and can end at a location associated with the arrival_location field 732 or the arrival_index field 736.

The vehicle data structure 710 can include one or more CapacityQuantity messages including the CapacityQuantity data structure 720. The CapacityQuantity data structure 720 can include or be associated with one or more capacities fields including the capacities field 722. The CapacityQuantity data structure 720 can be associated with the carrying capacity of a vehicle (e.g., an amount of a load that a vehicle is capable of carrying) and/or the consumption of that capacity by a shipment (e.g., an amount of a load that is waiting to be shipped). The capacities field 722 can be associated with the capacity of a vehicle including different types of quantities used to measure capacity (e.g., mass, weight, volume, and/or number of items). In some implementations, the capacities field 722 can be constrained by a demand for a capacity, which can be indicated by a shipment demand field. When the capacities field 722 is not defined the capacity can be assigned an infinite value. The infinite value assigned to the capacities field 722 can indicate that capacity for a vehicle is available, unavailable, or undetermined.

The departure_location field 730 can be associated with a location (e.g., a geographic location or latitude/longitude) of a vehicle including a location from which a vehicle departs before making a pick-up. In an implementation, when the departure_location field 730 is not specified or is not associated with a location, the departure_location 730 can be associated with a first shipment pickup location.

The arrival_location field 732 can be associated with a location (e.g., a geographic location or latitude/longitude) of a vehicle including a location of the vehicle after it has completed a final visit request (e.g., a visit to a designated location for a vehicle to perform). In an implementation, when the arrival_location field 732 is not specified or is not associated with a location, the shipment route associated with the vehicle ends after completion of the final visit request associated with the vehicle.

The departure_index field 734 can be used to determine a travel time for a first leg of a shipment by a vehicle. The travel time can be determined based accessing a travel time in a travel duration matrix (e.g., the travel duration matrix associated with the travel_duration_seconds field 640 in FIG. 6). In an implementation, when the departure_index field 734 is not specified, the location associated with the vehicle can be the location at which the vehicle will make its first pickup.

The arrival_index field 736 can be used to determine a travel time for a last leg of a shipment by a vehicle. The travel time can be determined based accessing a travel time in a travel duration matrix (e.g., the travel duration matrix associated with the travel_duration_seconds field 640 in FIG. 6). In an implementation, when the arrival_index field 736 is not specified, the location associated with the vehicle can be the location at which the vehicle will make its final visit request (e.g., final drop off of a shipment by the vehicle).

The earliest_start_time field 738 can specify a time at which the vehicle may depart for a shipment from a starting location (e.g., a departure location).

The latest_end_time field 740 can specify the time at which the vehicle may arrive at its ending location (e.g., an arrival location). In an implementation, the earliest_start_time field 738 and/or the latest_end_time field 740 can be associated with and/or constrained by a global time limit (e.g., a time limit that indicates a time range including the time the vehicle can arrive at a departure location and an arrival location). In an implementation, when the latest_start_time field 740 and/or the earliest_start_time field 742 are not specified, then the global time limit is the value on which the latest_start_time field 740 and/or the earliest_start_time field 742 can be based.

The cost_per_hour field 742 can specify a cost to the total time taken by the vehicle to travel a route as the vehicle makes a shipment. The total time can include a travel time (e.g., a time the vehicle uses in transit to or from a location), a waiting time (e.g., a time that the vehicle is waiting to pick-up or deliver a shipment), and a visiting time (e.g., a time for the vehicle to visit a location including transit and waiting times).

The cost_per_traveled_hour field 744 can specify a cost to the time taken by the vehicle in transit from one location to another without waiting time or visit time.

The fixed_cost field 746 can specify a cost (e.g., a default cost of a fixed amount) whenever the number of shipments made by a vehicle exceeds a minimum number of shipments (e.g., the vehicle makes at least one shipment).

In an implementation, the cost_per_hour field 742, the cost_per_traveled_hour field 744, and/or the fixed_cost field 746 can be associated with a penalty cost for a shipment that is not completed.

An example implementation of a vehicle data structure 710 is provided as follows:

message Vehicle {
google.type.LatLng departure_location = 1;
google.type.LatLng arrival_location = 2;
google.protobuf.Int32Value departure_index = 3;
google.protobuf.Int32Value arrival_index = 4;
google.protobuf.Timestamp earliest_start_time = 5;
google.protobuf.Timestamp latest_end_time = 6;
repeated CapacityQuantity capacities = 7;
double cost_per_hour = 9;
double cost_per_traveled_hour = 11;
double fixed_cost = 10;

}

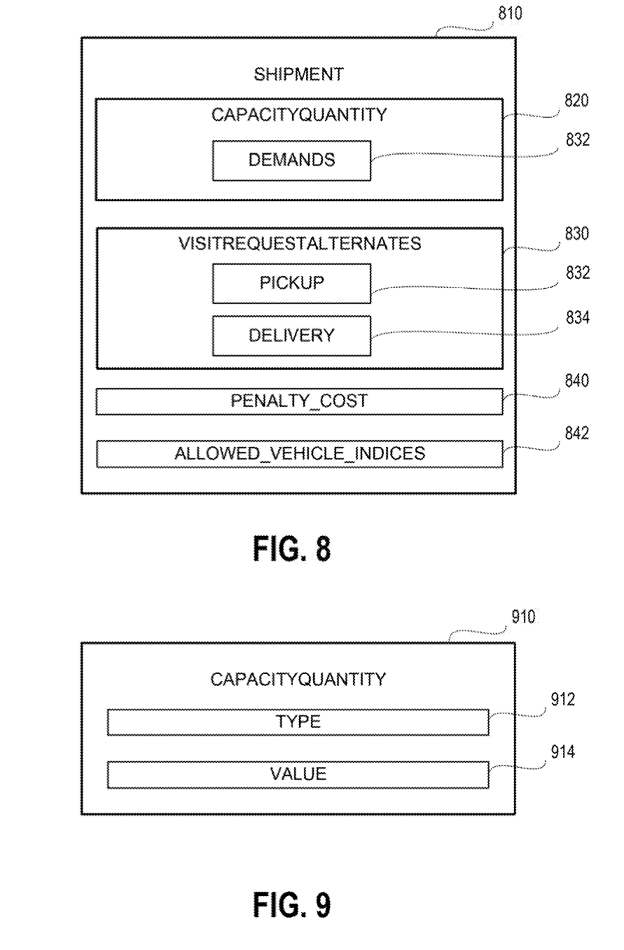

FIG. 8 depicts a block diagram of example sets of a shipment data structure 810 which can be associated with an API (e.g., the routing API 112) according to example embodiments of the present disclosure. One or more of the shipment data structure 810 can be executed or implemented on one or more computing devices or computing systems including, for example, the user device 102, the model data provider 104, and/or the computing device 302. Further, one or more of the shipment data structure 810 can be executed or implemented as an algorithm on the hardware components of the devices disclosed herein.

The shipment data structure 810 (e.g., a shipment message) can be associated with or include one or more data structures including a class, various objects, or a message that can be associated with a protocol buffer. The one or more data structures associated with the shipment data structure 810 can be associated with a set of shipments that can be picked up or delivered by a set of vehicles. The shipment data structure 810 can be associated with or include one or more of: a CapacityQuantity data structure 820 (e.g., a CapacityQuantity message) that can include a demands field 822; a vehicle message VisitRequestAlternates data structure 830 (e.g., a VisitRequestAlternates message) that can include a pickup field 832 and/or a delivery field 834; a penalty_cost field 840; and/or an allowed_vehicle_indices field 842.

The CapacityQuantity data structure 820 and an associated demands field can specify a type of a shipment and the quantity of a shipment. In an implementation, the quantity associated with the demand can be subtracted from the capacity of a vehicle after performing a pickup or added to the capacity of the vehicle after the vehicle performs a drop off. In an implementation, when the demand is not specified, the demand can be equal to a null value.

The VisitRequestAlternates data structure 830 can be associated with or include a pickup field or a delivery field. The pickup field to specify a pick-up location for a shipment and an optional delivery field can specify a drop-off location for a shipment. In some implementations, the shipment data structure 810 can include required data structures including at least one VisitRequestAlternates data structure 830 and no delivery or exactly one pickup VisitRequestAlternates data structure 830 and exactly one delivery associated with the VisitRequestAlternates data structure 830.

The penalty_cost field 840 can specify a penalty cost that is added to the overall route cost if a shipment is not completed (i.e., picked-up or delivered). The cost associated with the penalty_cost field 840 can be expressed in the same units as the cost used for other cost related fields. The allowed vehicle indices field 842 can specify the set of vehicles that can perform a shipment. In an implementation, when the allowed_vehicle_indices field 842 is empty, any vehicle in the shipment model can perform the shipment.

An example implementation of a shipment data structure 810 is provided as follows:

message Shipment {
VisitRequestAlternates pickup = 1;
VisitRequestAlternates delivery = 2;
repeated CapacityQuantity demands = 3;
google.protobuf.DoubleValue penalty_cost = 4;
repeated int32 allowed_vehicle_indices = 5;

}

FIG. 9 depicts a block diagram of example sets of a CapacityQuantity data structure 910 which can be associated with an API (e.g., the routing API 112) according to example embodiments of the present disclosure. One or more of the CapacityQuantity data structure 910 can be executed or implemented on one or more computing devices or computing systems including, for example, the user device 102, the model data provider 104, and/or the computing device 302. Further, one or more of the CapacityQuantity data structure 910 can be executed or implemented as an algorithm on the hardware components of the devices disclosed herein.

The CapacityQuantity data structure 910 (e.g., a Capacity Quantity message) can be associated with or include one or more data structures including a class, various objects, or a message that can be associated with a protocol buffer. The one or more data structures associated with the CapacityQuantity data structure 910 can be associated with a shipment model that includes a carrying capacity of a vehicle (e.g., a quantity that a vehicle is capable of carrying or transporting from one location to another location). Further, the CapacityQuantity data structure 910 can be associated with or include one or more of a type field 912 and/or a value field 914.

The type field 912 of the CapacityQuantity data structure 910 can be associated with or include an identifier of a type of quantity (e.g., mass in grams, weight in pounds, volume in liters, or length in meters) that can be associated with the capacity of a vehicle or consumption of that capacity by a shipment. The value field 914 can be associated with or include a value of the amount of the quantity associated with the capacity of a vehicle or consumption of that capacity by a shipment. For example, the value field 914 can include a numerical value (e.g., 15,000), which in combination with a type field 912 value of “kilograms” could indicate that the capacity of a vehicle is 15,000 kilograms. In some implementations, the value field can be limited to values that are equal to or greater than zero (i.e., non-negative values).

An example implementation of a CapacityQuantity data structure 910 is provided as follows:

message CapacityQuantity {

string type = 1;
int64 value = 2;

}

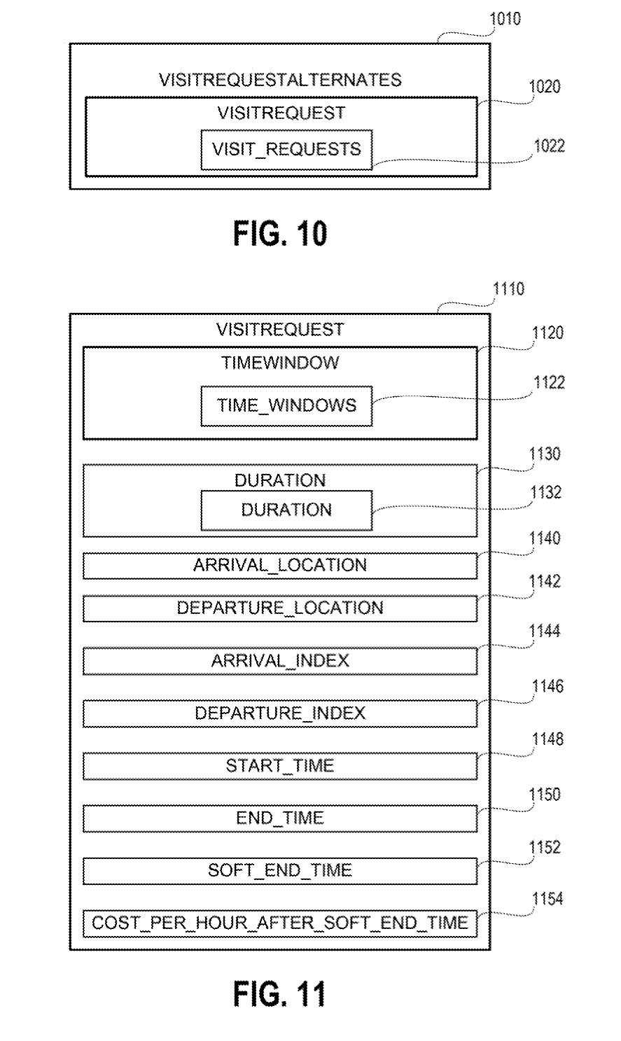

FIG. 10 depicts a block diagram of example sets of a VisitRequestAlternates data structure 1010 which can be associated with an API (e.g., the routing API 112) according to example embodiments of the present disclosure. One or more of the VisitRequestAlternates data structure 1010 can be executed or implemented on one or more computing devices or computing systems including, for example, the user device 102, the model data provider 104, and/or the computing device 302. Further, one or more of the VisitRequestAlternates data structure 1010 can be executed or implemented as an algorithm on the hardware components of the devices disclosed herein.

The VisitRequestAlternates data structure 1010 (e.g., a VisitRequestAlternates message) can be associated with or include one or more data structures including a class, various objects, or a message that can be associated with a protocol buffer. The one or more data structures associated with the VisitRequestAlternates data structure 1010 can be associated with a visit that can be performed by a vehicle. The VisitRequestAlternates data structure 1010 can be associated with or include one or more of a VisitRequest data structure 1020 (e.g., a VisitRequest message) that can include a visit requests field 1022.

The VisitRequestAlternates data structure 1010 can be associated with a set of visit requests which can be associated with the VisitRequestAlternates message 1020 and the visit_requests field 1022. Each of the visit requests associated with the VisitRequest data structure 1020 and the visit_requests field 1022 represents one logical visit by a vehicle to a location. In an implementation, the fulfillment of a visit request is satisfied by performance by the vehicle of one of the set of visit requests.

An example implementation of a VisitRequestAlternates data structure 1010 is provided as follows:

message VisitRequestAlternates {

repeated VisitRequest visit_requests = 1;

}

FIG. 11 depicts a block diagram of example sets of a VisitRequest data structure 1110 which can be associated with an API (e.g., the routing API 112) according to example embodiments of the present disclosure. One or more of the VisitRequest data structure 1110 can be executed or implemented on one or more computing devices or computing systems including, for example, the user device 102, the model data provider 104, and/or the computing device 302. Further, one or more of the VisitRequest data structure 1110 can be executed or implemented as an algorithm on the hardware components of the devices disclosed herein.

The VisitRequest data structure 1110 (e.g., a VisitRequest message) can be associated with or include one or more data structures including a class, various objects, or a message that can be associated with a protocol buffer. The one or more data structures associated with the VisitRequest data structure 1110 can be associated with a visit to be performed at a shipment location. The VisitRequest data structure 1110 can be associated with or include one or more of: a TimeWindow data structure 1120 (e.g., a TimeWindow message) that can include one or more of a: time_windows field 1122; a duration data structure 1130 (e.g., a duration message); a duration field 1132; an arrival_location field 1140; a departure_location field 1142; an arrival_index field 1144; a departure_index field 1146; a start_time field 1148; an end_time field 1150; a soft_end_time field 1152; and/or a cost_per_hour_after_soft_end_time field 1154.

The TimeWindow data structure 1120 can be used to represent one or more time windows that constrain a visit by a vehicle based on a value associated with the time_windows field 1122. The time_windows field 1122 which can indicate a number of time windows (e.g., a predefined time period) which can be associated with various events including an arrival time of a vehicle at a shipment location (e.g., an arrival time associated with the start_time field 1148), a departure time of a vehicle at a shipment location (e.g., a departure time associated with the end_time field 1150), and/or a soft end time (e.g., a soft end time associated with the soft_end_time field 1152).

The duration data structure 1130 can be used to represent the duration of a visit based on a value associated with the duration field 1132. For example, the duration of a visit by a vehicle to a location can be based on the time spent by the vehicle in transit between an arrival location and a departure location, as well as time that the vehicle has spent waiting to pick-up or drop-off a shipment.

The arrival_location field 1140 can be associated with a location (e.g., a geographic location or latitude/longitude) where a vehicle arrives when making a visit to a shipment location (e.g., a visit to a designated location for a vehicle to perform).

The departure_location field 1142 can be associated with a location (e.g., a geographic location or latitude/longitude) of a vehicle including a location from which a vehicle departs after completing a visit. In an implementation, the departure_location field 1142 can be omitted when it is associated with the same value (e.g., location) as the arrival location_field 1144. In an implementation, the arrival_location field 1140 and/or the departure_location field 1142 can include different values when associated with a geographic location that has different exit and entrance locations.

The arrival_index field 1144 can be used to determine (e.g., retrieve from a database) a time for a vehicle to arrive at a location from a previous departure location. The departure_index field 1146 can be used to determine (e.g., retrieve from a database) a time for a vehicle to depart from a location to a next arrival location.

The start_time field 1148 can specify a time at which arrives at a location. The end_time field 1150 can specify the time at which the vehicle may depart from a location. In an implementation, the start_time field 1148 and/or the end_time field 1150 can be associated with a soft_end_time field 1152. The soft_end_time field 1152 can specify a time for a vehicle to arrive at a location at or before the time associated with the soft_end_time field 1152. When a vehicle arrives at a location at the time specified by the soft_end_time field 1152, a cost associated with the cost_per_hour_after_soft_end_time field 1154 can be incurred by the vehicle.

An example implementation of a VisitRequest data structure 1110 is provided as follows:

message VisitRequest {

google.type.LatLng arrival_location = 1;
google.type.LatLng departure_location = 2;
google.protobuf.Int32Value arrival_index = 3;
google.protobuf.Int32Value departure_index = 4;
message TimeWindow {

google.protobuf.Timestamp start_time = 1;
google.protobuf.Timestamp end_time = 2;
google.protobuf.Timestamp soft_end_time = 3;
google.protobuf.DoubleValue
cost_per_hour_after_soft_end_time =4;

}
repeated TimeWindow time_windows = 5;
google.protobuf.Duration duration = 6;

}

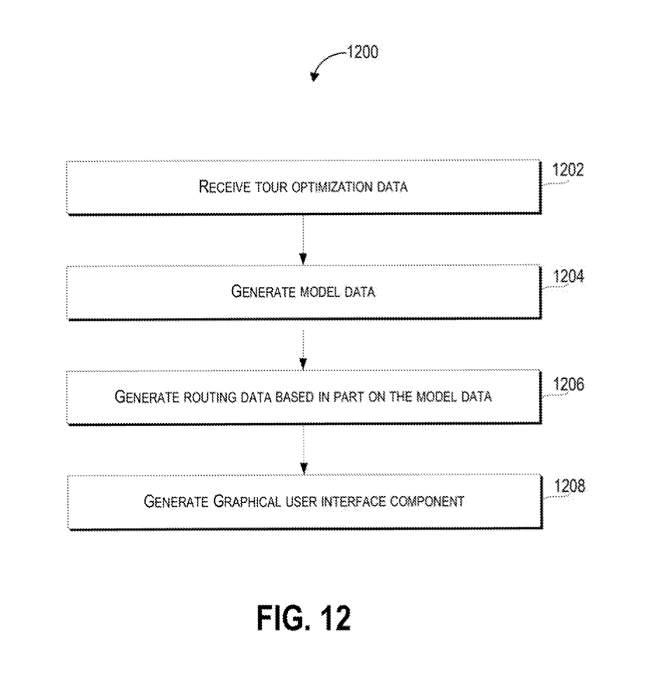

FIG. 12 depicts a flow diagram of an example method 1200 of generating navigation data for a software application according to example embodiments of the present disclosure. One or more portions of the method 1200 can be implemented using, for instance, the API 112 depicted in FIGS. 4-11. Further, one or more portions of the method 1200 can be executed or implemented on one or more computing devices or computing systems including, for example, the user device 102, the model data provider 104, and/or the computing device 302. One or more portions of the method 1200 can also be executed or implemented as an algorithm on the hardware components of the devices disclosed herein. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include, receiving data which can include tour optimization data. The tour optimization data can be received from one or more computing devices (e.g., local computing devices or remote computing devices) and can be received via an internal interconnect of a computing device to a local storage device or a communication network (e.g., a wireless or wired network including a LAN, WAN, or the Internet) through which a remote computing device can exchange one or more signals (e.g., electronic signals) or data. Further, the tour optimization data can be based on data received from one or more sensor devices that can be associated with one or more devices (e.g., vehicles) or locations (e.g., shipment locations). For example, the tour optimization data can be based on real-time data that is received from a plurality of shipment locations configured with one or more sensors to monitor the state of vehicles or shipments at the respective plurality of locations.

The tour optimization data can include one or more data structures (e.g., messages) including a tour optimization data structure associated with an application programming interface. The tour optimization data can specify a plurality of messages that can include one or more fields which can be associated with a set of shipments and a set of vehicles. The plurality of messages and the one or more fields can indicate the state of the set of shipments and the set of vehicles including respective properties or attributes of the set of shipments and the set of vehicles.

In an implementation, the tour optimization data can be based in part on a ShipmentModel data structure (e.g., the ShipmentModel data structure 610 in FIG. 6) or ShipmentModel message and can comprise the one or more shipment data structures (e.g., the shipment data structure 630 in FIG. 6) or shipment messages, a shipments field (e.g., the shipments field 632 in FIG. 6), the one or more vehicle data structures (e.g., the vehicle data structure 620 in FIG. 6) vehicle messages, a vehicles field (e.g., the vehicles field 622 in FIG. 6), a travel duration seconds field (e.g., the travel_duration_seconds field 640 in FIG,. 6), a global start time field (e.g., the global_start_time field 642 in FIG. 6), a global end time field (e.g., the global_end_time field 644 in FIG. 6), or a cost per hour of global duration field (e.g., the cost_per_hour_of_global_duration 646 in FIG. 6).

In an implementation, a portion of the one or more shipment messages and/or the one or more vehicle messages can be associated with one or more CapacityQuantity data structures (e.g., the CapacityQuantity data structure 910 illustrated in FIG. 9) or CapacityQuantity messages and can include a type field or a value field (e.g., the respective type field 912 and the value field 914 illustrated in FIG. 9). The type field can be associated with a type of a quantity demanded by the set of shipments or carried by the set of vehicles. The value field can be associated with an amount of the quantity demanded by the set of shipments or carried by the set of vehicles. Further, the set of shipments and the set of vehicles can be constrained by the type of the quantity associated with the type field or the amount of the quantity associated with the value field

In an implementation, the one or more vehicle data structures (e.g., the vehicle data structure 710 illustrated in FIG. 7) or vehicle messages can include at least one of the one or more CapacityQuantity data structures (e.g., the CapacityQuantity data structure 720 illustrated in FIG. 7) or CapacityQuantity messages, a capacities field (e.g., the capacities field 722 illustrated in FIG. 7), a departure location field (e.g., the departure_location field 730 illustrated in FIG. 7), an arrival location field (e.g., the arrival_location field 732 illustrated in FIG. 7), a departure index field (e.g., the departure_index field 734 illustrated in FIG. 7), an arrival index field (e.g., the arrival_index field 736 illustrated in FIG. 7), an earliest start time field (e.g., the earliest_start_time field 738 illustrated in FIG. 7), a latest end time field (e.g., the latest_end_time field 740 illustrated in FIG. 7), a cost per hour field (e.g., the cost_per_hour field 742 illustrated in FIG. 7), a cost per hour traveled field (e.g., the cost_per_traveled_hour field 744 illustrated in FIG. 7), or a fixed cost field (e.g., the fixed_cost field 746 illustrated in FIG. 7).

In an implementation, each of the one or more shipment data structures (e.g., the shipment data structure 810 illustrated in FIG. 8) or shipment messages can include at least one of the one or more CapacityQuantity messages (e.g., the CapacityQuantity data structure 820 illustrated in FIG. 8), one or more VisitRequestAlternates messages (e.g., the VisitRequestAlternates data structure 830 illustrated in FIG. 8), a pickup field (e.g., the pickup field 832 illustrated in FIG. 8), a delivery field (e.g., the delivery field 834 illustrated in FIG. 8), a demands field (e.g., the demands field 822 illustrated in FIG. 8), a penalty cost field (e.g., the penalty_cost field 840 illustrated in FIG. 8), and/or an allowed vehicle indices field (e.g., the allowed_vehicle_indices 842 illustrated in FIG. 8). The one or more CapacityQuantity messages can be associated with the demands field and the one or more VisitRequestAlternates messages can be associated with the pickup field or the delivery field. Further, each of the one or more VisitRequestAlternates data structures (e.g., the VisitRequestAlternates data structure 1010 illustrated in FIG. 10) or VisitRequestAlternates messages can be associated with or include one or more VisitRequest messages (e.g., the VisitRequest data structure 1020 illustrated in FIG. 10) or a visit requests field (e.g., the visit_requests field 1022 illustrated in FIG. 10).

The one or more VisitRequest data structures (e.g., the VisitRequest data structure 1110 illustrated in FIG. 11) or VisitRequest messages can include a TimeWindow data structure (e.g., the TimeWindow data structure 1120 illustrated in FIG. 11) or TimeWindow message, a duration message (e.g., the duration data structure 1130 illustrated in FIG. 11), a durations field (e.g., the duration field 1132 illustrated in FIG. 11) associated with the durations message, a time windows field (e.g., the time_windows field 1122 illustrated in FIG. 11) associated with the TimeWindow message, a duration field associated with the Duration message, an arrival location field (e.g., the arrival_location field 1140 illustrated in FIG. 11), a departure location field (e.g., the departure_location field 1142 illustrated in FIG. 11), an arrival index field (e.g., the arrival_index field 1144 illustrated in FIG. 11), a departure index field (e.g., the departure_index field 1146 illustrated in FIG. 11), a start time field, an end time field, a soft end time field, and/or a cost per hour after soft end time field (e.g., the VisitRequest message illustrated in FIG. 11).

Further, the TimeWindow message can be associated with the start time field (e.g., the start_time field 1148 illustrated in FIG. 11), the end time field (e.g., the end_time field 1150 illustrated in FIG. 11), the soft end time field (e.g., the soft_end_time field 1152 illustrated in FIG. 11), and/or the cost per hour after soft end time field (e.g., the cost_per_hour_after_soft_end_time field 1154 illustrated in FIG. 11). In some implementations, the set of shipments and the set of vehicles can be constrained by one or more of the CapacityQuantity message or the TimeWindow message.

At 1204, the method 1200 can include, generating model data. The mode data can be generated by one or more computing devices that process the model data (e.g., perform calculations based on properties or attributes of the model data). The model data can be based in part on one or more calls to a modeling function associated with the plurality of messages (e.g., a function that implements an API such as the routing API 112 in FIG. 1). The plurality of messages can be associated with the modeling function and comprise one or more shipment messages associated with the set of shipments and/or one or more vehicle messages associated with the set of vehicles. For example, the model data can include a shipment model that includes a plurality of vehicles and a plurality of shipments that are associated with various capacities, arrival times, departure times, and other properties associated with the messages and fields of the ShipmentModel.

At 1206, the method 1200 can include, generating, by the one or more computing devices, routing data for a user of the software application based in part on the model data. The routing data can include a set of routes that is based in part on the set of shipments and the set of vehicles. For example, a shipment model generated from the model data can include the plurality of vehicles and the plurality of shipments. The routing data can include a plurality of routes (e.g., travel routes for the vehicles between shipment locations including a pick-up location and a drop-off location).

In an implementation, the routing data can include a set of optimal routes according to one or more routing criteria that can be based on the state of the messages and fields associated with the model data (e.g., time constraints associated with the time window message and associated time windows field or capacity constraints associated with the CapacityQuantity message and the associated type field and value field). Further, generation of the routing data can include comparisons and evaluations of various portions of the model data including determinations of the aspects of the model data that satisfies the one or more routing criteria.

At 1208, the method 1200 can include, generating a graphical user interface component that is associated with the tour optimization service. The graphical user interface can include a combination of text or graphics that can display representations of data, including the model data or the routing data, to the user of the software application. Further, the graphical user interface component can be generated on a computing device (e.g., a smartphone) with a physical interface that can receive input (e.g., touch input or voice input) from a user to view various portions of the routing data. Further, the graphical user interface component can receive inputs in order to generate, modify, or process data associated with the model data or the routing data (e.g., selecting shipment criteria or generating different models based on different datasets).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A non-transitory computer-readable medium storing computer-readable instructions that implement an application programming interface for generating model data for a software application executed on a computing device having one or more processors and a display device, the application programming interface comprising:
a first set of instructions associated with a tour optimization data structure, the tour optimization data structure associated with the application programming interface and specifying a plurality of messages comprising one or more fields, wherein the plurality of messages is associated with a set of shipments and a set of vehicles;
a second set of instructions associated with a modeling function, the modeling function implementing one or more calls to generate the model data based in part on the plurality of messages; and
a third set of instructions associated with implementation of a tour optimization service to generate routing data for a user of the software application based in part on the model data, wherein the routing data comprises a set of routes based in part on the set of shipments and the set of vehicles.

2. The non-transitory computer-readable medium of claim 1, wherein the plurality of messages comprises one or more shipment messages associated with the set of shipments or one or more vehicle messages associated with the set of vehicles.

3. The non-transitory computer-readable medium of claim 2, wherein the tour optimization data is based in part on a ShipmentModel message comprising the one or more shipment messages, a shipments field, the one or more vehicle messages, a vehicles field, a travel duration seconds field, a global start time field, a global end time field, or a cost per hour of global duration field.

4. The non-transitory computer-readable medium of claim 2, wherein a portion of the one or more shipment messages or the one or more vehicle messages is associated with one or more CapacityQuantity messages comprising a type field or a value field.

5. The non-transitory computer-readable medium of claim 4, wherein the type field is associated with a type of a quantity demanded by the set of shipments or carried by the set of vehicles, and the value field is associated with an amount of the quantity demanded by the set of shipments or carried by the set of vehicles.

6. The non-transitory computer-readable medium of claim 5, wherein the set of shipments and the set of vehicles is constrained by the type of the quantity associated with the type field or the amount of the quantity associated with the value field.

7. The non-transitory computer-readable medium of claim 4, wherein the one or more vehicle messages comprises at least one of the one or more CapacityQuantity messages, a capacities field, a departure location field, an arrival location field, a departure index field, an arrival index field, an earliest start time field, a latest end time field, a cost per hour field, a cost per hour traveled field, or a fixed cost field.

8. The non-transitory computer-readable medium of claim 4, wherein each of the one or more shipment messages comprises at least one of the one or more CapacityQuantity messages, one or more VisitRequestAlternates messages, a pickup field, a delivery field, a demands field, a penalty cost field, or an allowed vehicle indices field, wherein the one or more CapacityQuantity messages are associated with the demands field and the one or more VisitRequestAlternates messages are associated with the pickup field or the delivery field.

9. The non-transitory computer-readable medium of claim 8, wherein each of the one or more VisitRequestAlternates messages comprises one or more VisitRequest messages or a visit requests field associated with the one or more VisitRequest messages.

10. The non-transitory computer-readable medium of claim 9, wherein the one or more VisitRequest messages comprises a TimeWindow message, a Duration message, a time windows field associated with the TimeWindow message, a duration field associated with the Duration message, an arrival location field, a departure location field, an arrival index field, a departure index field, a start time field, an end time field, a soft end time field, or a cost per hour after soft end time field.

11. The non-transitory computer-readable medium of claim 10, wherein the TimeWindow message is associated with the start time field, the end time field, the soft end time field, or the cost per hour after soft end time field.

12. The non-transitory computer-readable medium of claim 11, wherein the set of shipments and the set of vehicles is constrained by one or more of the CapacityQuantity message or the TimeWindow message.

13. The non-transitory computer-readable medium of claim 1, further comprising:
a fourth set of instructions comprising a graphical user interface component associated with the tour optimization service, wherein the graphical user interface displays the routing data to the user of the software application.

14. A method for generating navigation data for a software application executed on a computing device having one or more processors, the method comprising:
receiving, by one or more computing devices, tour optimization data comprising a tour optimization data structure associated with an application programming interface and specifying a plurality of messages comprising one or more fields, wherein the plurality of messages is associated with a set of shipments and a set of vehicles;
generating, by the one or more computing devices, model data based in part on one or more calls to a modeling function associated with the plurality of messages, wherein the plurality of messages associated with the modeling function comprises one or more shipment messages associated with the set of shipments or one or more vehicle messages associated with the set of vehicles; and
generating, by the one or more computing devices, routing data for a user of the software application based in part on the model data, wherein the routing data comprises a set of routes based in part on the set of shipments and the set of vehicles.

15. The method of claim 14, further comprising:
generating, by the one or more computing devices, a graphical user interface component associated with the tour optimization service, wherein the graphical user interface displays the routing data to the user of the software application.

16. The method of claim 14, wherein a portion of the one or more shipment messages or the one or more vehicle messages is associated with one or more CapacityQuantity messages comprising a type field or a value field, the type field associated with a type of a quantity demanded by the set of shipments or carried by the set of vehicles, and the value field associated with an amount of the quantity demanded by the set of shipments or carried by the set of vehicles.

17. The method of claim 16, further comprising:
constraining, by the one or more computing devices, the set of shipments and the set of vehicles based in part on the type of the quantity associated with the type field or the amount of the quantity associated with the value field.

18. A computing device comprising:
a network interface;
one or more processors; and
one or more memory devices, wherein the one or more memory devices store computer-readable instructions that implement an application programming interface invoked by a software application to generate model data for a tour optimization service as part of the software application, the instructions comprising:
a first set of instructions associated with a tour optimization data structure, the tour optimization data structure associated with the application programming interface and specifying a plurality of messages comprising one or more fields, wherein the plurality of messages is associated with a set of shipments and a set of vehicles;
a second set of instructions associated with a modeling function, the modeling function implementing one or more calls to generate the model data based in part on the plurality of messages; and
a third set of instructions associated with implementation of the tour optimization service to generate routing data for a user of the software application based in part on the model data, wherein the routing data comprises a set of routes based in part on the set of shipments and the set of vehicles.

19. The computing device of claim 18, wherein a portion of the one or more shipment messages or the one or more vehicle messages is associated with one or more CapacityQuantity messages comprising a type field or a value field, the type field associated with a type of a quantity demanded by the set of shipments or carried by the set of vehicles, and the value field associated with an amount of the quantity demanded by the set of shipments or carried by the set of vehicles.

20. The computing device of claim 19, further comprising:
constraining the set of shipments and the set of vehicles based in part on the type of the quantity associated with the type field or the amount of the quantity associated with the value field.
